(19) United States
(12) Patent Application Publication
(10) Pub. No.: US 2005/0084572 A1
(43) Pub. Date: Apr. 21, 2005

(54) Method and apparatus for irradiating foodstuffs using low energy x-rays

(76) Inventors: John T. Lindsay, Pinckney, MI (US); Peter F. Schoch, Ann Arbor, MI (US)

Correspondence Address: Christopher A. Mitchell;YOUNG & BASILE, P.C., Suite 624, 3001 West Big Beaver Road, Troy, MI, 48084-3107, US

(21) Appl. No.: 10/960,819

(22) Filed: Oct. 7, 2004

Related U.S. Application Data
(60) Provisional application No. 60/509,351, filed on Oct. 7, 2003.

(51) Int. Cl. A23L 3/00

(52) U.S. Cl. 426/240

(57) ABSTRACT

The specification discloses a method and apparatus for irradiating foodstuffs. The method comprises the step of exposing a foodstuff to be irradiated to x-rays having energies selected exclusively from the range of below approximately 250 KeV, for a period of time and at at least a first intensity sufficient to provide a desired dose of radiation to the foodstuff. The inventive apparatus comprises, in a first embodiment, a conduit adapted for the movement therethrough of a foodstuff to be irradiated, the conduit having a passageway defined between inlet and outlet ends thereof; means for moving the product to be irradiated through the conduit at at least a first velocity; and at least one x-ray tube disposed within the conduit passageway between the inlet and outlet ends in the path of travel of the foodstuff to be irradiated, the at least one x-ray tube being selectively capable of generating x-rays having energies exclusively in the range of below approximately 250 KeV. According to an alternative embodiment, the apparatus comprises the aforesaid conduit and means for moving the foodstuff to be irradiated, while providing at least one x-ray tube positioned substantially external of the conduit and arranged so that an x-ray beam emitted by the at least one x-ray tube is propagated substantially in a direction that is perpendicular to the path of travel of the foodstuff to be irradiated through the passageway. The at least one x-ray tube is selectively capable of generating x-rays having energies exclusively in the range of below approximately 250 KeV.

### CROSS-REFERENCE TO RELATED APPLICATIONS

This application is related to, and claims the benefit of priority from, U.S. Provisional Patent Application Ser. No. 60/509,351, filed Oct. 7, 2003.

Statement Regarding Federally Sponsored

Research or Development

Not applicable.

Incorporation By Reference of Material

Submitted on a Compact Disc

Not applicable.

### FIELD OF THE INVENTION

The present invention pertains to foodstuff processing with ionizing energy, and more particularly to a method and apparatus for processing foodstuffs through the exclusive employment of low-energy (i.e., in the range of less than approximately 250 KeV) x-rays.

### BACKGROUND

In the United States alone, as many as 9,000 deaths annually are believed to be attributable to food-borne pathogens such as salmonella, listeria, Escherichia coli (:E-coli”), trichinella, staphylococcus, etc. And, for at least the years 1997-2000, there was a significant annual increase in the number of food products recalled by reason of contamination.

High-energy ionizing radiation has long been employed to treat foodstuffs such as spices, wheat, wheat flour and potatoes. More recently, such ionizing energy has begun to be employed in the treatment of foodstuffs such as meat, including poultry and pork. See, e.g., FDA (HHS) Final Rule on the Use of Irradiation in the Production, Processing, and Handling of Food, Federal Register 50, 29658-29659 (July 1985). The increasing use irradiation technology has been driven by the growing incidents of sickness and death attributable to food-borne pathogens. Presently, some twenty-seven countries employ irradiation in food processing. In the United States, the Food and Drug Administration (FDA) and the Department of Agriculture (USDA) are responsible for the establishment of regulatory guidelines respecting food irradiation processes. These guidelines specify the maximum radiation dosage to be delivered to any given food or beverage product, as well as the minimum log reduction in pathogens achievable by the irradiation process.

Foodstuff irradiation is currently carried out using one or more of the following types of ionizing energy: Gamma rays; high-energy x-rays; and high-energy electrons. Gamma ray sources are by far the most prevalent type of ionizing energy used in the food processing industry. These sources typically consist of large quantities of radioactive Cobalt (Co⁶⁰) or Cesium (Cs¹³⁷). Gamma ray sources generally have from 1 to 5 discrete energy gammas, as opposed to a continuous energy spectrum such as x-ray sources. Gamma ray sources are thus characterized as discrete energy sources. Gamma rays have energies in the range of from about 0.66 to greater than 10 million electron volts (MeV). Such high-energy gamma rays are able to significantly penetrate relatively dense foodstuffs, such as poultry and meats, as well as large volumes, such as palletized foodstuffs. However, gamma radiation sources suffer from a number of drawbacks which have thus far hampered the wider expansion of their use in food processing. As gamma radiation is a continuous emission (i.e., it cannot be “turned off”), as well as being harmful to humans, the source material (i.e., Co⁶⁰ or Cs¹³⁷) must be encapsulated in metal enclosures and stored in a deep pool of water when not in use in order to provide adequate protection for workers and the surrounding environment. This translates into the need for large, non-mobile facilities and, consequently, the need to ship foodstuffs from diverse locations to the gamma radiation source for treatment. It is, moreover, difficult to provide uniform radiation doses to a variety of foodstuffs, making the employment of gamma ray sources undesirable for a more comprehensive array of foodstuffs.

High-energy x-rays may be produced by accelerating electrons at high speeds onto a high Z (atomic number) target material, typically tungsten, tantalum, and stainless steel. Those electrons stopping in the target material produce a continuous energy spectrum of x-rays. The method of producing high energy electrons most commonly used today produces x-rays as a result of igniting an electron cyclotron resonance plasma inside an evacuated dielectric spherical chamber filled with a heavy atomic weight, non-reactive gas or gas mixture at low pressure. The spherical chamber is located inside a non-evacuated microwave resonant cavity that is in turn located between two magnets to form a magnetic mirror. Conventional microwave energy fed into the resonant cavity ignites the plasma and creates a hot electron ring from which electrons bombard the heavy gas and dielectric material to create an X-ray emission. The disclosures of U.S. Pat. Nos. 5,461,656, and 5,838,760 are exemplary. Lower energy x-rays are then filtered from this spectrum to provide a beam capable of penetrating through larger items while still maintaining a relatively uniform absorption rate throughout the foodstuff being irradiated. To further ensure dosage uniformity, the foodstuff being irradiated is typically reversed in direction and orientation from the direction and orientation in which the exposure was initially made. While the high-energy x-rays conventionally used in the irradiation of foodstuffs have energies as high as 5 MeV (i.e., 5,000,000 electron Volts), there is a reported trend toward even higher-energy (i.e., about 10 MeV) x-rays in order to increase their penetrating power. See, e.g., Report of the Consultant's Meeting on the Development of X-Ray Machines for Food Irradiation, Food and Agriculture Organization, IAEA, A-1400 (Vienna, Austria 1995). The use of high-energy x-rays is not as prevalent in the food irradiation industry primarily because conventional x-ray tubes are extremely energy inefficient. Only about 2% of energy input is translated into useful x-ray energy, the remainder being given off as heat (which must be dissipated through the expenditure of further energy).

High-energy (i.e., ≈10 MeV) electrons, originally obtained from linear accelerators and Van de Graff generators, are characterized by the lowest penetrating power of currently-employed ionizing energy, and are therefore limited to use where the thickness of the foodstuff being irradiated is less than a few inches in depth.

One major drawback to conventional foodstuff irradiation methodologies is the adverse impact on taste. Fruit juices, such as orange juice and grapefruit juice, in particular evidence a marked increase in bitterness following irradiation by gamma rays and high-energy electrons. Other conventional beverage treatment methods, such as for instance heat pasteurization, likewise adversely affect the taste of these products.

It would therefore be desirable to have a means for irradiating foodstuffs which is at once economical, does not adversely affect the flavor of treated (i.e., irradiated) products, may be selectively activated and deactivated, may be employed “on-site” at the facility of a food producer (e.g., manufacturer, packager/bottler, etc.), has none of the adverse effects of radioactive materials, and which otherwise alleviates public apprehension about the use of radioactive isotopes as the treating radiation.

### SUMMARY OF THE DISCLOSURE

The specification describes both a method and apparatus for irradiating foodstuffs, including food and beverage products such as meats, juices, seafood, poultry products, fruits, vegetables, etc., characterized by the exclusive employment of low energy (i.e., in the range of below approximately 250 KeV) x-rays. The method generally comprises the step of exposing a food or beverage product to be irradiated to x-rays having energies selected exclusively from the range of below approximately 250 KeV for a period of time and at at least a first intensity sufficient to provide a desired dose of radiation to the foodstuff. The method may be employed to eliminate unwanted organisms, including pathogens, organisms implicated in spoilage, insects, etc. Additionally, the method may be employed to achieve such results without adversely affecting the taste of the irradiated foodstuff.

According to one feature of this invention, in which the method thereof is specifically employed to eliminate unwanted pathogens, the foodstuff to be irradiated is characterized by an initial pathogen population, and the desired dose of radiation is sufficient to achieve at least a predetermined reduction in the initial pathogen population.

According to still another feature hereof, the foodstuff is characterized by an initial taste, and the desired dose of radiation does not alter the initial taste.

Per still another feature of the instant invention, the method further comprises the step of mixing the foodstuff during exposure to the x-rays, by which step it has been found that the period of time of exposure may be reduced as compared to not mixing, and, thus, that a more uniform dose of radiation may be imparted to the foodstuff being irradiated in a shorter interval than might otherwise be possible.

According to one embodiment, the present invention comprises a method for irradiating orange juice having an initial pathogen population and an initial taste, comprising the step of exposing the orange juice to be irradiated to x-rays having energies selected exclusively from the range of below approximately 250 KeV for a period of time and at at least a first intensity sufficient to provide a dose of radiation to the orange juice that is sufficient to achieve at least a predetermined reduction in the initial pathogen population without altering the initial taste. Per a further embodiment, the x-rays have energies in the range of below approximately 60 KeV.

According to one embodiment thereof, the inventive apparatus generally comprises: A conduit adapted for the movement therethrough of a foodstuff to be irradiated, the conduit having a inlet and outlet ends and a passageway defined therebetween, the inlet and outlet ends defining a path of travel through the conduit for the foodstuff to be irradiated; means for moving the foodstuff to be irradiated through the conduit at at least a first velocity; and at least one x-ray tube disposed within the passageway between the inlet and outlet ends and in the path of travel of the foodstuff, the at least one x-ray tube being selectively capable of generating an x-ray beam having energies exclusively in the range of below approximately 250 KeV.

According to a further embodiment, the inventive apparatus comprises: A conduit adapted for the movement therethrough of a foodstuff to be irradiated, the conduit having inlet and outlet ends and a passageway defined therebetween, the inlet and outlet ends defining a path of travel through the conduit for the product to be irradiated; means for moving the product to be irradiated along the path of travel through the conduit at at least a first velocity; and at least one x-ray tube positioned substantially external of the conduit and arranged so that an x-ray beam emitted by the at least one x-ray tube is propagated substantially in a direction that is perpendicular to the path of travel through the passageway of the foodstuff to be irradiated, the at least one x-ray tube being selectively capable of generating an x-ray beam having energies exclusively in the range of below approximately 250 KeV.

The x-ray tube or tubes employed in the apparatus of this invention may, as desired, variously comprise one or more or several disclosed embodiments of x-ray tubes, in addition to, or in substitution of, conventional x-ray tube.

According to one embodiment, an x-ray tube is provided which comprises a housing having an x-ray outlet end, an anode positioned proximate the outlet end, and at least one cathode spaced-apart from the anode, characterized in that electrons traveling from the at least one cathode to the anode strike the anode in an unfocused manner. According to another feature thereof, the at least one x-ray tube may be characterized by the absence of filters for filtering from the x-rays propagated by the at least one x-ray tube x-rays having energies in the range of below approximately 250 KeV.

Per yet another embodiment, an x-ray tube is provided which is characterized by an anode having angled surfaces, such that the x-ray beam propagated by the at least one x-ray tube is outwardly expanding in the direction of propagation thereof.

According to still another embodiment, a x-ray tube is provided which comprises a housing having a peripheral surface, and at least one cathode and at least one anode disposed therein, wherein the at least one anode is positioned proximate the peripheral surface such that the x-ray beam propagated by the at least one x-ray tube radiates from the peripheral surface of the housing. Per one feature thereof, the housing comprises a cylinder having a longitudinal axis, the peripheral surface comprises a circumferential surface, the at least one cathode is disposed generally coaxial with the longitudinal axis of the housing, and the at least one anode is positioned proximate the entire circumferential surface of the housing such that the x-ray beam propagated by the at least one x-ray tube radiates in all directions from the circumferential surface of the housing.

### BRIEF DESCRIPTION OF THE DRAWINGS

The present invention may be better understood with reference to the written description and drawings, of which:

FIG. 1 comprises a graph comparing the x-ray spectrum of the inventive methodology with an x-ray spectrum comprehending the energies used in conventional food irradiation methods;

FIG. 2 comprises a graph depicting the efficacy of low-energy x-rays in eliminating pathogenic organisms;

FIG. 3 diagrammatically illustrates an x-ray tube of conventional construction;

FIG. 4 diagrammatically illustrates an x-ray tube of improved construction which is particularly suited to use in the method of the present invention;

FIG. 5 is a graph comparing the energy spectra of an x-ray tube of conventional construction with the x-ray tube of FIG. 4;

FIG. 6 diagrammatically illustrates a second embodiment of an x-ray tube of improved construction which is particularly suited to use in the method of the present invention;

FIGS. 7a and 7b diagrammatically illustrate a third embodiment of an x-ray tube of improved construction which is particularly suited to use in the method of the present invention;

FIG. 8 diagrammatically illustrates a first embodiment of an apparatus for carrying out the methodology of the instant invention, the apparatus comprising one single-ended x-ray tube disposed within a conduit defining a path of travel for a foodstuff being irradiated;

FIG. 9 depicts an alternate embodiment of the apparatus of FIG. 8, wherein one double-ended x-ray tube is disposed within the conduit, the x-ray tube propagating x-ray fields in opposite directions within the conduit;

FIG. 10 depicts an alternate embodiment of the apparatus of FIG. 8, wherein two single-ended x-ray tubes are disposed within the conduit, the x-ray tubes arranged end-to-end so that there respective x-ray fields are propagated in opposite directions within the conduit;

FIGS. 11a and 11b diagrammatically illustrate a further embodiment of an apparatus for carrying out the methodology of the instant invention, the apparatus comprising one single-ended x-ray tube disposed externally of a conduit defining a path of travel for a foodstuff being irradiated, the x-ray field being propagated into the conduit in a direction generally perpendicular to the path of travel through the conduit of the foodstuff being irradiated;

FIGS. 12a and 12b depict in diagram an alternate embodiment of the apparatus of FIGS. 11a and 11b, wherein two single-ended x-ray tubes are disposed externally of the conduit, the x-ray tubes arranged in opposition so that their respective x-ray fields are propagated along substantially the same axis of propagation in opposite directions to thereby create an overlapping x-ray field within the conduit;

FIG. 13 diagrammatically shows an alternate embodiment of the apparatus of FIGS. 11a and 11b, wherein three single-ended x-ray tubes are disposed externally of the conduit, the x-ray tubes being arranged equidistant from each other with their respective x-ray fields being propagated so as to create an overlapping x-ray field within the conduit; and

FIG. 14 diagrammatically illustrates an alternate embodiment of the apparatus of FIGS. 11a and 11b, wherein four single-ended x-ray tubes are disposed externally of the conduit, the x-ray tubes being arranged equidistant from each other with their respective x-ray fields being propagated so as to create an overlapping x-ray field within the conduit.

### WRITTEN DESCRIPTION

As used herein, the following terms shall have the definitions as ascribed hereafter:

The term “low energy” refers to x-rays having energies exclusively in the range of below approximately 250 KeV, which range comprehends at least 250 KeV as the upper limit thereof.

The term “dose” means and refers to the amount of radiation absorbed by the product exposed to such radiation.

“KeV” is a unit of measurement comprehending thousands of electron Volts (e.g., 1 KeV=1,000 electron Volts).

“MeV” is a unit of measurement comprehending millions of electron Volts (e.g., 1 MeV=1,000,000 electron Volts).

“Rads” or “radiation absorbed dose” is a unit of measurement defined as 100 ergs absorbed by 1 gram of matter.

The “Gray,” or “Gy,” means and refers to a unit of measurement equivalent to 100 rads/kg.

A “kilogray,” or “kGy,” is equivalent to 1000 Gray.

The present invention is most generally characterized as a method, and apparatus therefor, for irradiating foodstuffs, including food and beverage products such as, by way of non-limiting example, meats, poultry products, seafood, vegetables, fruits, nuts, spices, juices, etc., through the employment of low-energy x-rays—i.e., those having energies exclusively in the spectrum of below approximately 250 KeV—for a period of time sufficient to provide a desired dose of radiation to the foodstuff being irradiated. According to one aspect thereof, the present invention is characterized as a method, using such low-energy x-rays, of irradiating foodstuffs having an initial pathogen population, wherein the desired dose of radiation is sufficient to achieve at least a predetermined reduction in the initial pathogen population. Per yet another aspect thereof, the present invention is characterized as method, using such low-energy x-rays, of irradiating foodstuffs having an initial pathogen population and an initial taste, wherein the desired dose of radiation achieves the desired reduction in the initial pathogen population without altering the initial taste, the inventors hereof having surprisingly and unexpectedly discovered that low-energy x-rays are capable of irradiating foodstuffs in satisfaction of government regulations respecting the elimination of pathogens, while not adversely affecting the taste of the foodstuff.

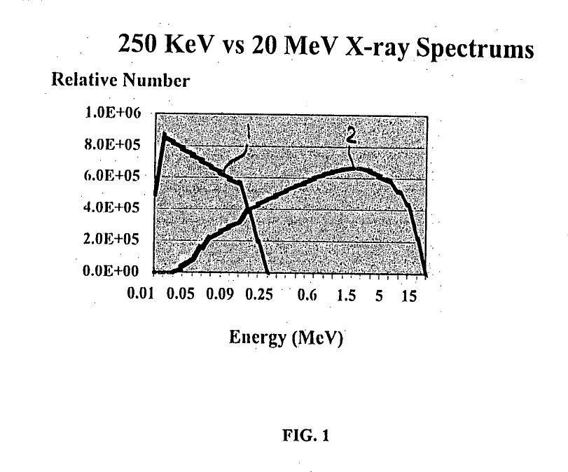

Turning first to FIG. 1, which figure compares the x-ray spectrum of the inventive methodology (line 1) with an x-ray spectrum comprehending the energies of conventional food irradiation methods (line 2), it will be appreciated that the prior art not only comprehends energies significantly beyond the upper limits contemplated by the instant invention, but further filters out a significant portion of the energy spectrum employed by this invention.

While not desiring to be bound by any particular theory, the inventor hereof believes that the advantages of employing low-energy x-rays in the irradiation of foodstuffs, a methodology believed to be heretofore unknown in the art, may be attributed to the fact that low-energy x-ray irradiation, having energies falling in the photoelectric-effect domain, is sufficient to irreparably damage the deoxyribonucleic acid (DNA) or ribonucleic acid (RNA) structure of food-borne and beverage-borne pathogens, non-pathogenic organisms, and other life forms, such as insects, while advantageously causing insufficient damage to enzymes and other proteins to affect the taste of the irradiated product.

As indicated, the inventive method essentially comprises treating a selected foodstuff with low-energy x-rays at at least a first intensity and for a period of time sufficient to provide a desired dose of radiation. The low-energy x-rays have an energy spectrum selected exclusively from the range of below approximately 250 KeV.

It will be appreciated by those of skill in the art that a “desired dose” may, depending upon the circumstances, be dictated by government regulations or other third party requirements respecting the nature of the product being irradiated. In the United States, for example, the FDA specifies that poultry meats treated by irradiation must receive doses of from 1.5 kGy to 3.0 kGy, while fresh (i.e., not frozen) red meats must receive a dose of 4.5 kGy. The determination of dose received by an irradiated product may be carried out by any conventional means, all known to those of ordinary skill in the art.

Experiments were carried out in demonstration of the efficacy of the inventive methodology in eliminating pathogens, and in treating selected foodstuffs with x-rays having energies selected exclusively from the range of below approximately 250 KeV without adversely affecting the taste of such foodstuffs.

### EXAMPLE 1

### Experimental

Using a Varian MCS 7000 Series x-ray tube with a Varian Model HE1256 heat exchanger (output measured at 214,400 rad/minute), various 100 cc samples of fresh, unpasteurized orange juice were exposed to one or the other of x-rays having maximum energies of approximately 75 keV and approximately 150 keV. Exposure times were 1, 2, 5, 10, 15, 20, 35 and 60 minutes. Test vessels for the 100 cc orange juice sample included glass and plastic containers certified for human use. For each said 100 cc sample, exposures were cumulative. That is, for example, a 100 cc sample in a glass container was exposed to low-energy x-rays for each of the indicated exposure times in succession, thereby accumulating the final dose received by the sample.

Using various conventional methods, it was determined that the final dose received by each sample was in excess of 1 MegaRad (1,000,000 rads). This dosage exceeds by a factor of twenty the 1.5 kGy dosage specified for orange juice by the FDA as being necessary to achieve a 5-log reduction in pathogens. Notwithstanding this high dosage, the taste of the orange juice samples was unaffected, as determined qualitatively.

### EXAMPLE 2

### Experimental

Using a Varian MCS 7000 Series x-ray tube with a Varian Model HE1256 heat exchanger (output measured at 214,400 rad/minute), pathogen-containing samples of deionized water were subjected to various doses of x-rays having energies exclusively in the range of below approximately 60 KeV in order to determine the efficacy of the inventive method in eliminating pathogens.

The test pathogen comprised E. coli ATTC No. 35421, a Coliform bacteria selected for its relatively high vigor and surrogate properties. The initial sample population of bacteria was established by transferring a loop of stock solution to several plates of Endo agar medium, adapted from Clesceri et al., Standard Methods for the Examination of Water and Wastewater (20^{th} ed.), at 9222B. Unless otherwise specified, the foregoing and other protocols discussed in relation to this example were adapted from Clesceri et al., Standard Methods for the Examination of Water and Wastewater (20^{th} ed.), published by the American Public Health Association, the American Waterworks Association, and the Water Environment Federation.

The thus-transferred bacteria were incubated at 35-37° C. for 24 hours, whereupon the plates were inspected to ensure that the colony-forming units (“CFU's”) comprised Coliform bacteria. Several typical Coliform colonies were subsequently transferred to six (6) separate tubes of EC-MUG media, as specified in Standard Methods for the Examination of Water and Wastewater, supra, at 9221 F, and the fluorescence characteristics of the samples evaluated to confirm the presence of E. coli.

Aliquots of the foregoing characteristic CFU's were next transferred to a bottle of Lactose broth and incubated for 48 hours at 35-37° C. The resulting solution was designated as the “Stock Standard.”

In final confirmation of the presence of Coliform as E. coli, a loop of the Stock Standard solution was transferred to a dish of Endo agar, as well as being deposited in the EC-MUG medium, and the characteristics of E. coli colonies established therefrom.

From the foregoing Stock Standard, multiple 125 ml test samples of the E. coli pathogens suspended in deionized water were prepared, with each sample comprising about 1 million organisms per ml. These samples were maintained at 4° C. pending irradiation using x-rays with energies in the range of below approximately 60 KeV for the durations set forth in Table I, below. The maximum dose received by each sample was estimated to be well below 1.5 kGy.

TABLE I

| | |
|---|---|
| Sample Identification | Irradiation Time |

| | | |
|---|---|---|
| Bk-31 | 1 | hrs |
| Bk-32 | 0.5 | hrs |
| Bk-33 | 1 | hrs |
| Bk-34 | 1.5 | hrs |
| Bk-35 | 2 | hrs |
| Bk-53 | 0 | hrs |
| Bk-54 | 4 | hrs |
| Bk-55 | 7 | hrs |
| Bk-56 | 10 | hrs |
| Bk-57 | 0 | hrs |

As reflected by the absence of irradiation (“Irradiation Time”=0) the specimens designated Bk-31, Bk-53 and Bk-57 constituted the controls for these experiments.

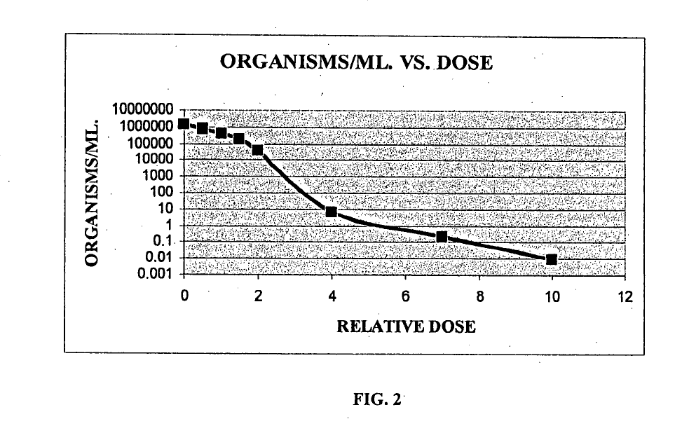

Referring now to each Table II and of FIG. 2, reproduced below, the results for the samples irradiated in accordance with Table I are presented. With respect to Table II in particular, the data represent the average number of organisms calculated to be present in plated extracts of E. coli either diluted (using 99 ml phosphate buffer) from the corresponding sample by the indicated dilution factor (provided in the “Dilution/Filtration” column of Table II) using the pour plate method of Standard Methods for the Examination of Water and Wastewater, supra, at 9215 B, or filtered from the indicated quantity (in ml, also provided in the “Dilution/Filtration” column of Table II) of the original sample using the membrane filter method of Standard Methods for the Examination of Water and Wastewater, supra, at 9215 D. More particularly, each count represents the average population per ml of three quantifications conducted for each sample at the indicated dilutions and filtrations. The parenthetical numbers reflect the average population per ml normalized to the control sample Bk-31, the samples Bk-53 through Bk-57 having been prepared, irradiated, and evaluated subsequently. The indicated dilution factors of Table II were determined based upon the expected efficacy of irradiation for each sample, in view of the need to realize no more than 300 colonies per plate necessary to ensure accurate quantification of the plated organisms. As will be appreciated, the number of organisms present in the total 125 ml volume of each irradiated sample can be determined by multiplying the plated count by the corresponding dilution factor.

TABLE II

| Sample Identification | Method of Analysis | Average Population Per ml | Dilution/Filtration |
|---|---|---|---|
| Bk-31 | Total Plate Count | 1,230,389 | 1:100,000 and 1:10,000 |
| Bk-32 | Total Plate Count | 694,833.3 | 1:10,000 and 1:1,000 |
| Bk-33 | Total Plate Count | 353,833.3 | 1:10,000 and 1:1,000 |
| Bk-34 | Total Plate Count | 168,933.3 | 1:1,00 and 1:100 |
| Bk-35 | Total Plate Count | 37,278 | 1:10 and 1:1 |
| Bk-53 | Total Plate Count | 1,041,667 | 1:100,000 and 1:10,000 |
| Bk-54 | Total Plate Count | 5 (6.041188) | 1:100 and 1:10 |
| Bk-55 | Total Plate Count | 0.588889 (0.204617) | 1:1/5 ml and 10 ml |
| Bk-56 | Total Plate Count | 0.244444 (0.008948) | 1:1/10 ml and 30 m |
| Bk-57 | Total Plate Count | 995,000 | 1:100,000 and 1:10,000 |

Referring particularly to FIG. 2, the same plots the calculated average population per ml for each of the samples Bk-31 through Bk-25, Bk-54, Bk-55, and Bk-56 from Table II, above, against the relative dose of x-ray irradiation received by each sample. As clearly evidenced, the inventive method of employing low-energy x-rays is more than sufficient to achieve a significant reduction in the initial pathogen population. And, more specifically in relation to the example shown, the over 7-log reduction achieved in the original sample populations exceeds the FDA's requirement that a foodstuff-treatment method achieve no less than a 5-log reduction in the pathogen population of the treated foodstuff.

It will be appreciated from the foregoing that the method of this invention may be employed not only to significantly reduce an initial pathogen population from foodstuffs, and further to do so without adversely affecting the taste of such foodstuffs, but further to eliminate non-pathogenic organisms which may nevertheless be implicated in the spoilage of foodstuffs. Thus, for example, it is contemplated that low-energy x-rays may be employed to treat whole or otherwise unprocessed foodstuffs to eliminate or reduce the presence of organisms, including non-pathogenic microbes, insects, etc., which may cause spoilage or otherwise reduce the shelf-life thereof. It will likewise be appreciated form this disclosure that while the irradiation of orange juice is exemplified, the methodology of this invention may be transposed to the treatment of numerous other Foodstuffs with no more than routine experimentation by varying the maximum energy of the low-energy x-rays employed, as well as the duration and intensity of the exposure, in order to determine the energy, time and intensity necessary to provide a desired dose of radiation to the foodstuff, whether the desired result is the elimination of pathogenic or other organisms, or the same coupled with the preservation of the initial, pre-irradiated taste of the foodstuff.

In connection with the aforementioned considerations, the inventors hereof have further discovered that mixing of the foodstuff may be employed during irradiation in order to decrease the duration of exposure to the x-rays and increase the uniformity of the dose absorbed, while ensuring that the entire foodstuff being irradiated receives the desired dose. Necessarily, the degree of mixing will vary according to such considerations as the dimensions of the apparatus employed to accommodate the foodstuff during irradiation, as well as the nature of the foodstuff being irradiated.

While the inventive methodology may be practiced using conventional x-ray generating apparatus, the inventors hereof further disclose alternative x-ray generating apparatus for carrying out the aforedescribed process of irradiating foodstuffs using low-energy x-rays.

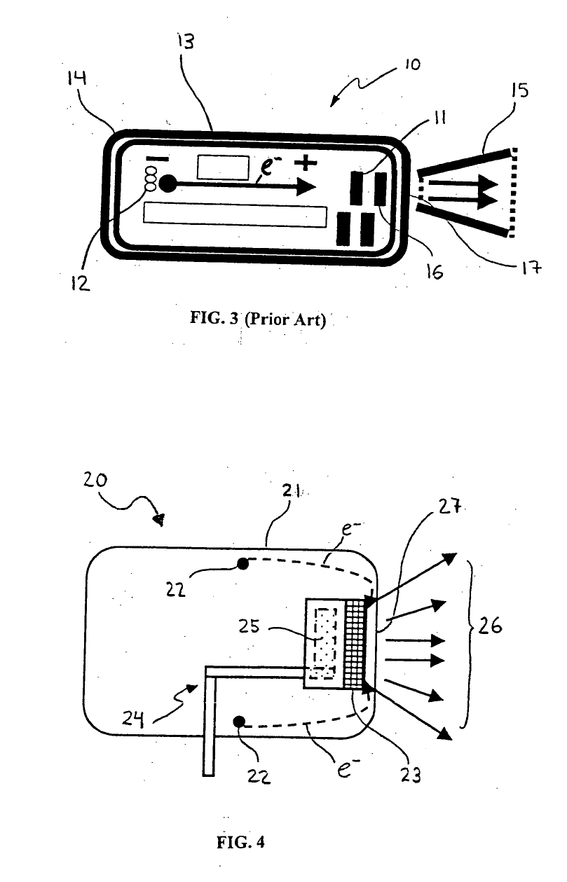

Conventional x-ray generating apparatus, such as the x-ray tube 10 diagrammatically shown in FIG. 3, includes a target material 11. The target material 11 is typically an element with a high Z (atomic) number, and usually comprises tungsten (Z=84), although other materials, including tantalum (Z=73), rhodium, copper, chromium, platinum, and molybdenum, as well as alloys such as rhenium-tungsten-molybdenum, are also used. X-rays are produced by accelerating electrons e⁻ at high speeds toward this target material 11. Upon the accelerated electrons e⁻ striking the target material 11, x-rays are produced in two forms. The first form, commonly referred to as bremsstrahlung radiation, is the product of deviations in the trajectory of accelerated electrons as they pass the nuclei of target atoms. The second form, known as characteristic radiation, is the product of the interaction between accelerated electrons and inner-shell electrons of the target atoms. More particularly, the accelerated electrons ionize inner shell electrons in the target atoms, causing outer shell electrons to move to occupy the “hole” created by the excited inner shell electron. This movement of each outer shell electron to an inner shell is accompanied by the emission of photons in the x-ray spectrum by the target atoms' electrons. The majority of any given x-ray field typically comprises bremmstrahlung-type radiation. Conventionally, acceleration of the electrons e⁻ is accomplished by creating a large voltage potential across a finite space defined between a positive anode comprising the target material 11, and a negative cathode comprising a filament circuit 12 (e.g., tungsten). Alternatively, however, electron acceleration may conventionally be accomplished by having an anode maintained at ground potential, with the cathode having a high negative potential. These elements are contained in a glass vacuum enclosure 13, which is in turn contained within a metal shielding enclosure 14 used to absorb the emission therefrom of all but the desired x-rays 15. A suitable power source (not shown in FIG. 3) supplies the current to create the necessary electrical potential, and powers the filament circuit 12, which must be heated to incandescence to provide the source of accelerated electrons e⁻. Conventional x-ray tubes further include cooling means, as the vast majority (approximately 98%) of radiation produced when the accelerated electrons e⁻ strike the target 11 is infrared (i.e., heat). Included among these cooling means is rotation of the anode 11. Conventional x-ray tubes such as shown in FIG. 3 are further characterized by significant amounts of filtration materials 16 such as, for instance, aluminum (and other low Z metal) sheets, to reduce the intensity of the x-ray beam 15 by absorbing lower energy photons. Further filtration also takes place as the x-ray beam exits the tube, passing first through an oil layer (not shown) and then through a beryllium (typically) window 17.

Referring now to FIG. 4, one novel x-ray generating apparatus 20 particularly suited to the method and apparatus of this invention will be seen to comprise at least one externally-grounded housing 21 containing both anode 23 and cathode 22 assemblies. The housing 21, as well as all other foodstuff-contacting surfaces of the apparatus 20 are preferably manufactured from stainless steel. Suitable materials for the target anode 23 include those conventionally known and commercially available from numerous sources, including, without limitation, materials such as rhodium, copper, chromium, platinum, molybdenum and tungsten, as well as alloys thereof. Instead, the anode 23 is sufficiently cooled by water or other suitable medium via a cooling circuit 24 including a heat exchanger 25 disposed proximate the anode 23. Of course, other conventional cooling apparatus and means known to those of skill in the art may also be employed as necessary. The anode 23 is maintained at ground potential, thus decreasing the need for insulating the apparatus. Each of cathodes 22 comprise a filament circuit, which may be tungsten or other known substitute therefor. The electrons e⁻ produced at each cathode 22 are, by means of magnets (not shown) such as is known in the art, bent oppositely towards the anode 23. Importantly, the accelerated electrons e⁻ are not focused on a particular location on the anode 23. Rather, the path of these electrons e⁻ between each cathode 22 and the anode 23 is expanded such that the x-ray beam 26 produced when the electrons e⁻ strike the target anode 23 has a greater area than that characterizing conventional x-ray tubes. By reason of this configuration, the apparatus does not generate as much heat as conventional x-ray tubes, and so the anode 23 may be non-rotating. In order to further increase the area of the x-ray beam 26, the anode 23 is preferably positioned as close as possible to the outlet end 27 of the tube 20. The apparatus 20 is, by reason of this design, more energy efficient as a greater fraction of the energy converted into x-rays comprises the emerging x-ray beam. For whereas the x-rays comprising the emerging beam in conventional x-ray tubes is approximately 2% of x-rays produced, the x-ray tube of the present invention employs in the emerging x-ray beam as much as 40% of the x-rays produced. As shown, the x-ray beam 26 is preferably propagated along the longitudinal axis of the tube 20 and emerges through an opening at the outlet end 27. According to this arrangement, an x-ray tube is provided which is smaller in transverse dimensions than conventional x-ray tubes, and so may be more easily incorporated into foodstuff irradiation apparatus such as hereinafter described in several embodiments. In order to maximize the emission of low-energy x-rays from the apparatus 20 as described, it is further preferred to eliminate those filtration means found in conventional x-ray tubes, including aluminum sheets, oils, a beam exit window, and other means employed to eliminate low-energy x-rays from the emerging beam.

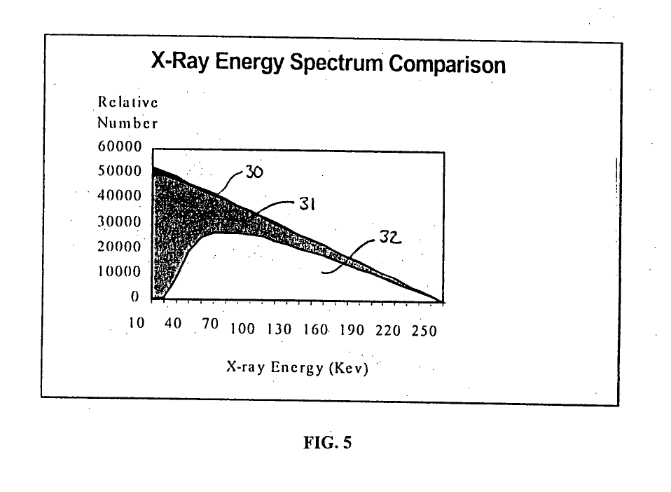

Turning now to FIG. 5, a graph is illustrated which depicts the inventor's experimental data comparing the output beam of an x-ray tube such as described herein-above in reference to FIG. 4 with the output beam of a conventional x-ray tube such as described in reference to FIG. 3. More particularly, the compared data comprise the relative number of x-rays generated at each energy. In this example, the energy spectra of both tubes ranges from approximately 1 KeV to approximately 250 KeV for purposes of meaningful comparison, although, as previously indicated, the employment of low-energy x-rays was heretofore unknown for the irradiation of foodstuffs. As compared to the theoretical energy spectrum (comprising the sum of the areas in solid black 30, grey 31, and white 32) achievable from each of the compared x-ray tubes, it will be appreciated that conventional x-ray tubes (the energy spectrum of which comprises the area in white) filter out a significant portion of x-ray energies. In contrast, the x-ray tube disclosed hereinabove will be seen to have an energy spectrum (comprising the sum of the areas in grey and white) insubstantially different from the theoretical energy spectrum.

Turning next to FIG. 6, a further novel x-ray generating apparatus 20′ likewise suited to the method and apparatus of this invention will, as with the apparatus of FIG. 4, be seen to comprise at least one externally-grounded housing 21′ containing both anode 23′ and cathode 22′ assemblies, the anode 23′ cooled by water or other suitable medium via a cooling circuit 24′ including a heat exchanger 25′ disposed proximate the anode 23′. In this and other respects the apparatus 20′ is comparable to the apparatus described above in relation to FIG. 4, except that the anode 23′ and cathode 22′ assemblies are modified to from the previous embodiment to further maximize the area of the x-ray beam 26′. More specifically, it will be seen that the target anode 23′ is characterized by at least a pair of angled striking faces, while the cathode assembly 22′ comprises a pair of cathodes, one positioned proximate each such striking face of the target anode. By this arrangement, the x-ray beam 26′ produced when the electrons e⁻ strike the target anode 23′ has a greater area than that characterizing either conventional x-ray tubes or even the apparatus of FIG. 4.

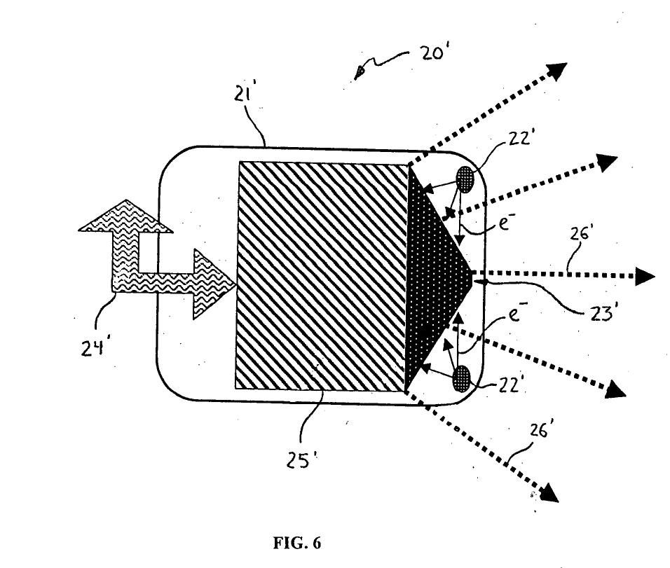

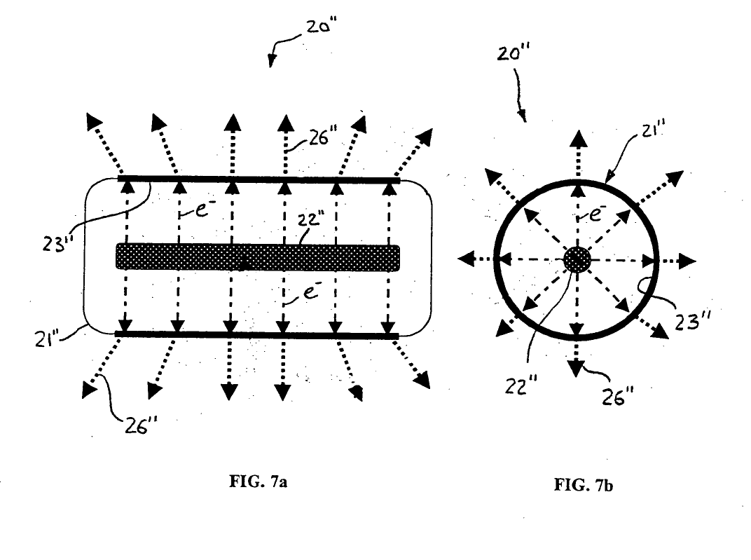

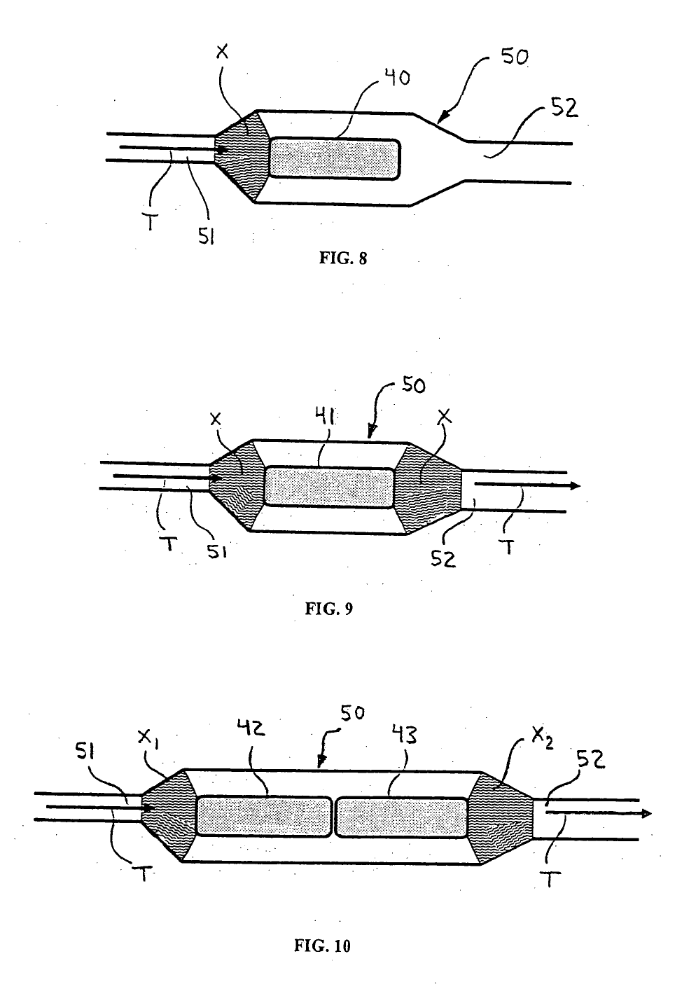

Referring next to FIGS. 7a and 7b, there is depicted diagrammatically a further x-ray generating apparatus which is suited to the method and apparatus of this invention, and particularly well suited to employment in the apparatus of FIGS. 8 through 14 described further hereinbelow. According to this illustrated embodiment, the x-ray generating apparatus 20″ includes a cathode assembly 22″ centrally disposed in a housing 21″ comprising the target anode 23″. Suitable materials for the target anode 23 include those conventionally known and commercially available from numerous sources, including, without limitation, materials such as rhodium, copper, chromium, platinum, molybdenum and tungsten, as well as alloys thereof. The anode 23″ may be cooled by water or other suitable medium via a cooling circuit (not shown) including a heat exchanger (not shown) disposed proximate the anode 23″, as well as by other conventional cooling apparatus and means known to those of skill in the art. Alternatively, the anode 23″ may, when the x-ray apparatus 20″ of this embodiment is employed in an apparatus such as shown and described in relation to any of FIGS. 8-14, be sufficiently cooled by the movement of a foodstuff over the exterior surface of the apparatus 20″. As shown, the electrons e⁻ produced at cathode 22″ radiate outwardly towards the anode 23″, such that the resultant the x-ray beam 26″ is likewise propagated radially outwardly from the apparatus 20″. According to this arrangement, an x-ray tube is provided which effectively irradiates the area in the vicinity of the entire circumference thereof.

With reference now being had to FIGS. 8-14, several exemplary food-irradiating apparatus for carrying out the methodology of the present invention are diagrammatically illustrated. In each of these embodiments, the apparatus may include one or more x-ray tubes according to the configuration described above in relation to any of FIGS. 4, 6, 7a or 7b. However, the several apparatus shown in FIGS. 8-14 are not intended to be so limited, and it will be appreciated from this disclosure that conventional x-ray tubes may be substituted.

In each of the following embodiments, a foodstuff to be irradiated (not shown) is moved through a conduit 50 along a path of travel T from an inlet end 51 to an outlet end 52, traveling through at least one x-ray field or beam propagated by at least one x-ray tube. To convey the foodstuff through the apparatus, any mechanism suitable to the foodstuff being irradiated may be employed, including, without limitation, pumps, screws, impellers, etc. To ensure uniform dosing of the foodstuff being irradiated, it may be desired to provide means for adequately mixing the foodstuff as it moves through the conduit 50. The mixing means may, by way of example, include baffles arranged within the conduit 50 to produce turbulent mixing, or mechanical mixing or agitating means such as impellers, etc.

Referring more particularly to FIG. 8, the food-irradiating apparatus according to a first embodiment will be seen to comprise a single x-ray tube 40 centrally disposed in a conduit 50 between the inlet 51 and outlet 52 ends thereof. As shown, the x-ray beam or field X is propagated toward the conduit inlet end 51 and against the direction of travel T through the conduit 50 of the product being irradiated. As the product being irradiated moves in the indicated direction of travel T from the inlet end 31 to the outlet end 32, it is thus continuously exposed to the ionizing energy X of the x-ray tube 40.

In a second embodiment, shown in FIG. 9, an x-ray tube 41 of double-ended design is provided, according to which x-ray fields X are propagated from opposite ends of the x-ray tube 41 toward each of the inlet 51 and outlet 52 ends of the illustrated conduit 50. By this arrangement, exposure of the foodstuff being irradiated to the low-energy x-rays is augmented over the embodiment of FIG. 8.

In a third embodiment, shown in FIG. 10, the apparatus comprises two x-ray tubes 42 and 43 arranged end-to-end along a substantially common longitudinal axis. The x-ray field X₁ of the first tube 42 is propagated toward the inlet end 51 of the conduit 50, while the x-ray field X₂ of the second tube 43 is propagated toward the outlet end 52 of the conduit 50.

In each of the foregoing embodiments, food-contacting surfaces of the conduit 50 are preferably of stainless steel construction. Lead shielding (not indicated) may also be provided to ensure that no x-rays travel beyond the confines of the conduit 50.

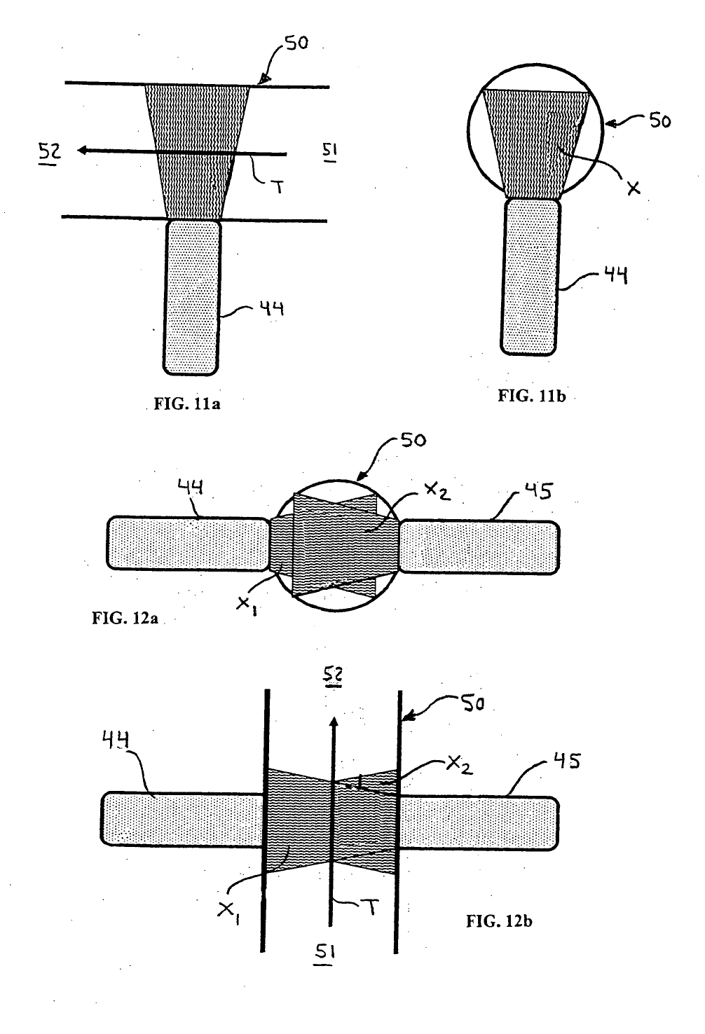

Turning now to FIGS. 11-14, the apparatus of the illustrated embodiments is characterized in that the x-ray tube or tubes are largely disposed outside of the conduit 50, with the x-ray field(s) X being propagated into the conduit 50 in a direction substantially perpendicular to the path of travel T through the conduit, from the inlet 51 to the outlet 52 ends thereof, of the foodstuff being irradiated.

According to the embodiment of FIGS. 11a and 11b, which depict the apparatus diagrammatically in both lateral and transverse sections, a single such x-ray tube 44 is provided; while, in the embodiment of FIGS. 12a and 12b, two such x-ray tubes 44 and 45 are disposed oppositely on the conduit 50, their respective x-ray fields X₁ and X₂ being propagated along substantially the same axis in opposite directions to thereby create an overlapping x-ray field within the conduit 50.

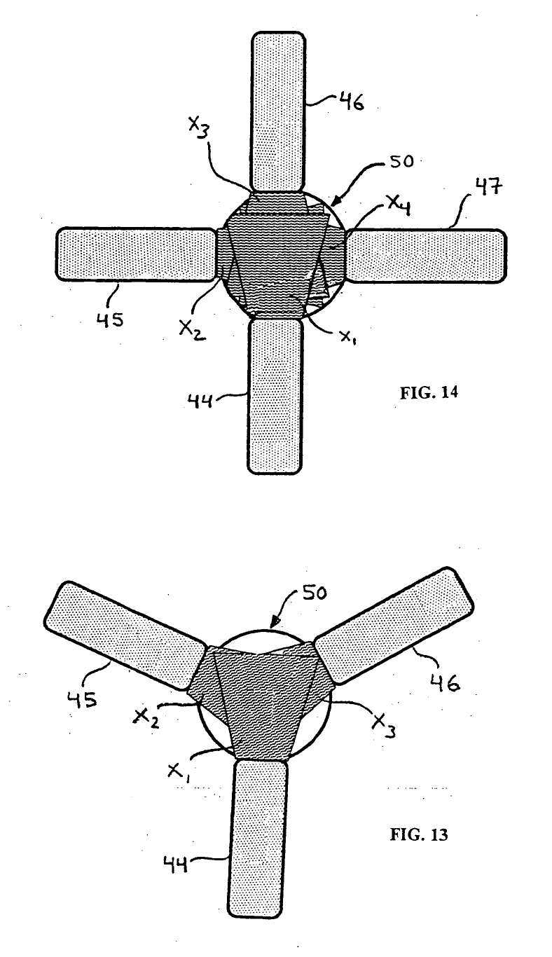

In the embodiment of FIG. 13, three x-ray tubes 44, 45, and 46 are provided, each arranged equidistant from the other about the circumference of the conduit 50 at an angle of 120° as measured from the longitudinal axis of each tube. Finally, the embodiment of FIG. 14 provides four x-ray tubes 44, 45, 46, and 47, each arranged equidistant from the other about the circumference of the conduit 50 at an angle of 90°, also as measured from the longitudinal axis of each x-ray tube.

Alternatively, it is contemplated that the plural x-ray tubes of the embodiments of FIGS. 11-14 may, in each such embodiment, be staggered along the longitudinal axis of the conduit 50, instead of being arranged so that their respective x-ray fields are propagated along substantially the same axis in opposite directions.

It will be understood, with reference to each of the foregoing examples, that the rate of movement through the conduit and past the x-ray field(s) of the foodstuff being irradiated will be dictated by the necessity of ensuring proper dosing, which in turn is a function of the intensity of the x-ray field and the duration of exposure.

It will also be understood that the foregoing embodiments may be employed in combination in a single operational environment. Thus, for example, the first embodiment's single x-ray tube arranged within a conduit (FIG. 8) may be used at one point in a foodstuff irradiation process, while at a subsequent point in the same process the fourth embodiment's single x-ray tube disposed outside a conduit (FIG. 11) may be employed.

It will be appreciated from the above disclosure that the present invention improves upon the prior art by providing a method, and related apparatus, for the irradiation of foodstuffs that is at once efficacious and easily employed, which may eliminate unwanted pathogens or other organisms, including without adversely affect product taste, and which further does not suffer from the public concern over the use of radioactive isotopes such as Co⁶⁰.

Of course, the foregoing is merely illustrative of the present invention, and those of ordinary skill in the art will appreciate that many additions and modifications to the present invention, as set out in this disclosure, are possible without departing from the spirit and broader aspects of this invention as defined in the appended claims.

1. A method for irradiating foodstuffs, comprising the step of exposing a foodstuff to be irradiated to x-rays having energies selected exclusively from the range of below approximately 250 KeV for a period of time and at at least a first intensity sufficient to provide a desired dose of radiation to the foodstuff.

2. The method of claim 1, wherein the foodstuff is characterized by an initial pathogen population, and the desired dose of radiation is sufficient to achieve at least a predetermined reduction in the initial pathogen population.

3. The method of claim 2, wherein the foodstuff is characterized by an initial taste, and the desired dose of radiation does not adversely alter the initial taste.

4. The method of claim 1, wherein the foodstuff is characterized by an initial organism population, and the desired dose of radiation is sufficient to achieve a reduction in the initial organism population.

5. The method of claim 1, further comprising the step of mixing the foodstuff during exposure to the x-rays.

6. The method of claim 3, wherein the foodstuff comprises orange juice.

7. A method for irradiating orange juice having an initial pathogen population and an initial taste, comprising the step of exposing the orange juice to be irradiated to x-rays having energies selected exclusively from the range of below approximately 250 KeV for a period of time and at at least a first intensity sufficient to provide a dose of radiation to the orange juice that is sufficient to achieve at least a predetermined reduction in the initial pathogen population without altering the initial taste.

8. The method of claim 8, further comprising the step of mixing the orange juice during exposure to the x-rays.

9. An apparatus for irradiating foodstuffs, the apparatus comprising:
A conduit adapted for the movement therethrough of a foodstuff to be irradiated, the conduit having inlet and outlet ends and defining a passageway therebetween, the inlet and outlet ends defining a path of travel through the conduit for the foodstuff to be irradiated;
Means for moving the foodstuff to be irradiated through the conduit at at least a first velocity; and
At least one x-ray tube disposed within the passageway between the inlet and outlet ends in the path of travel of the foodstuff to be irradiated, the at least one x-ray tube capable of emitting an x-ray beam having energies exclusively in the range of below approximately 250 KeV.

10. The apparatus of claim 9, wherein the at least one x-ray tube comprises two x-ray tubes arranged end-to-end along substantially the same axis, and wherein further the x-ray beam of each said x-ray tube is propagated in a direction opposite from, but on substantially the same axis as, that of the other of said x-ray tubes.

11. The apparatus of claim 9, wherein the at least one x-ray tube comprises a housing having an x-ray outlet end, an anode positioned proximate the outlet end, and at least one cathode spaced-apart from the anode, characterized in that electrons traveling from the at least one cathode to the anode strike the anode in an unfocused manner.

12. The apparatus of claim 11, wherein further the at least one x-ray tube is characterized by the absence of filters for filtering from the x-ray beam propagated by the at least one x-ray tube x-rays having energies in the range of below approximately 250 KeV.

13. The apparatus of claim 10, wherein the at least one x-ray tube comprises a housing having an x-ray outlet end, an anode positioned proximate the outlet end, and at least one cathode spaced-apart from the anode, characterized in that electrons traveling from the at least one cathode to the anode strike the anode in an unfocused manner.

14. The apparatus of claim 13, wherein further the at least one x-ray tube is characterized by the absence of filters for filtering from the x-ray beam propagated by the at least one x-ray tube x-rays having energies in the range of below approximately 250 KeV.

15. The apparatus of claim 9, wherein the at least one x-ray tube is characterized by an anode having angled surfaces, such that the x-ray beam propagated by the at least one x-ray tube is outwardly expanding in the direction of propagation thereof.

16. The apparatus of claim 10, wherein the at least one x-ray tube is characterized by an anode having angled surfaces, such that the x-ray beam propagated by the at least one x-ray tube is outwardly expanding in the direction of propagation thereof.

17. The apparatus of claim 9, wherein the at least one x-ray tube comprises a housing having a longitudinal axis and a peripheral surface arranged transverse of the longitudinal axis, and at least one cathode and at least one anode disposed therein, wherein the at least one anode is positioned proximate the peripheral surface such that the x-ray beam propagated by the at least one x-ray tube radiates from the peripheral surface of the housing.

18. The apparatus of claim 17, wherein the housing comprises a cylinder having a longitudinal axis, the peripheral surface comprises the circumferential surface of the cylinder, the at least one cathode is disposed generally coaxial with the longitudinal axis of the housing, and the at least one anode is positioned proximate the circumferential surface of the housing such that the x-ray beam propagated by the at least one x-ray tube radiates in substantially all radial directions from the circumferential surface of the housing.

19. The apparatus of claim 10, wherein the at least one x-ray tube comprises a housing having a longitudinal axis and a peripheral surface arranged transverse of the longitudinal axis, and at least one cathode and at least one anode disposed therein, wherein the at least one anode is positioned proximate the peripheral surface such that the x-ray beam propagated by the at least one x-ray tube radiates from the peripheral surface of the housing.

20. The apparatus of claim 19, wherein the housing comprises a cylinder having a longitudinal axis, the peripheral surface comprises the circumferential surface of the cylinder, the at least one cathode is disposed generally coaxial with the longitudinal axis of the housing, and the at least one anode is positioned proximate the circumferential surface of the housing such that the x-ray beam propagated by the at least one x-ray tube radiates in substantially all radial directions from the circumferential surface of the housing.

21. An apparatus for irradiating foodstuffs, the apparatus comprising:
A conduit adapted for the movement therethrough of a foodstuff to be irradiated, the conduit having inlet and outlet ends and defining a passageway therebetween, the inlet and outlet ends defining a path of travel through the conduit for the foodstuff to be irradiated;
Means for moving the foodstuff to be irradiated along the path of travel through the conduit at at least a first velocity; and
At least one x-ray tube positioned substantially external of the conduit and arranged so that an x-ray beam emitted by the at least one x-ray tube is propagated substantially in a direction that is perpendicular to the path of travel of the foodstuff to be irradiated through the passageway, the at least one x-ray tube being capable of emitting an x-ray beam having energies exclusively in the range of below approximately 250 KeV.

22. The apparatus of either of claim 21, wherein the at least one x-ray tube comprises a housing having an x-ray outlet end, an anode positioned proximate the outlet end, and at least one cathode spaced-apart from the anode, characterized in that electrons traveling from the at least one cathode to the anode strike the anode in an unfocused manner.

23. The apparatus of claim 22, wherein further the at least one x-ray tube is characterized by the absence of filters for filtering from the x-ray beam x-rays having energies in the range of below approximately 250 KeV.

24. The apparatus of either of claim 22, wherein the at least one x-ray tube is characterized by an anode having angled surfaces, such that the x-ray beam propagated by the at least one x-ray tube is outwardly expanding in the direction of propagation.
